(19) United States
(12) Patent Application Publication
(10) Pub. No.: US 2025/0103612 A1
(43) Pub. Date: Mar. 27, 2025

(54) NON FUNGIBLE TOKEN FEATURE EXTENSIONS

(71) Applicants: Clifford Rees Morgan, II, Placerville, CA (US); Edward L Wong, Jr., Miami, FL (US)

(72) Inventors: Clifford Rees Morgan, II, Placerville, CA (US); Edward L Wong, Jr., Miami, FL (US)

(21) Appl. No.: 18/371,607

(22) Filed: Sep. 22, 2023

(51) Int. Cl. G06F 16/27

(52) U.S. Cl. CPC G06F 16/27

(57) ABSTRACT

Systems and methods of NFT features are disclosed wherein a computer performs the steps of, first retrieving an NFT token JSON file and determining at least one label stored in the JSON file. At least one registry is checked for display information associated with the at least one label. The NFT is then displayed in an NFT wallet according to the display information.

### TECHNICAL FIELD

Embodiments of the invention relate to systems and methods for Non-Fungible Tokens (NFTs) features.

### BACKGROUND

NFTs are digital assets that represent real-world and virtual objects. These can include works of art, videos, images, songs, sneakers, collectibles, virtual in-game or in-platform items, and a wide variety of others. NFTs have recently become popular as a way to buy and sell artwork in particular. Essentially, they are digital collector's items. NFTs are often encoded using blockchain technology, similar in many respects to cryptocurrency.

NFTs allow people to buy and sell original items and are popular because they contain built-in authentication and cannot be forged since each NET has a unique digital signature. This provides some sense of digital bragging rights for their owners. As a result of their rising popularity and natural scarcity, some NFTs have been sold for large sums of money. For example, social media platform Twitter's co-founder sold an NFT of his first tweet for more than $2.9 million.

Thus, it would be beneficial and needs exist for new NFT features.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The example embodiments provided herein relate to and disclose NFT functions. The embodiments provide a means for extending the features of ERC-721 tokens by defining additional JSON file meta data “labels” along with how a digital wallet should display the JSON file meta data labels. The system allows for complete legal documents to be added to a folder to which the JSON file is directed using the IRI contained in the token, thus extending the token's capabilities. The system may also add an email label to a digital wallet to permit the system to transmit data from the IRI storage folder, allowing for the digital wallet to contain the transmitted data.

Some current embodiments permit automobile title transfers through sales.

Some current embodiments are related to determining how best to display an NFT.

Some current embodiments provide for email files to be NFT linked.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRA WINGS

A more complete understanding of the embodiments, and the attendant advantages and features thereof, will be more readily understood by references to the following detailed description when considered in conjunction with the accompanying drawings wherein:

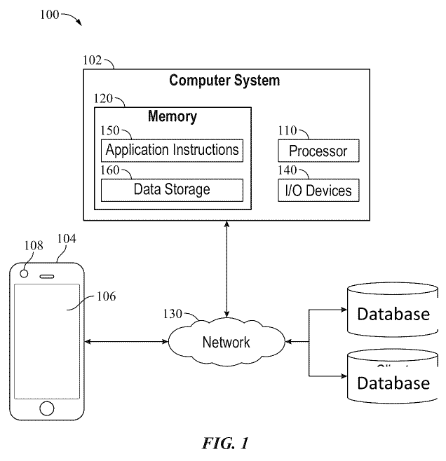

FIG. 1 illustrates a system architecture diagram, according to some embodiments;

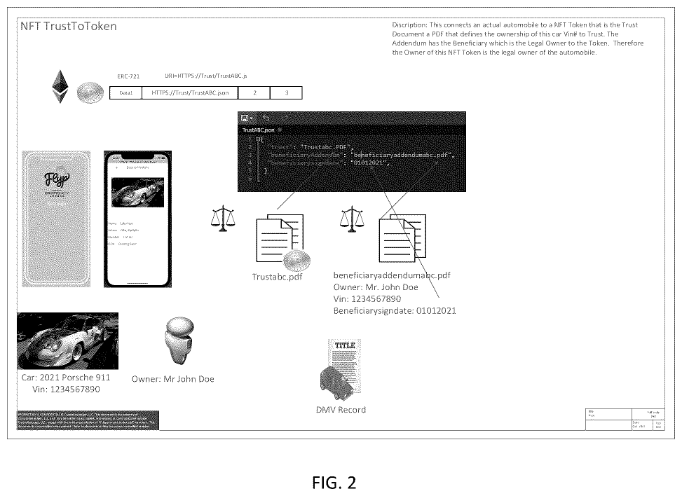

FIG. 2 illustrates a NFT trust to token feature, according to some embodiments;

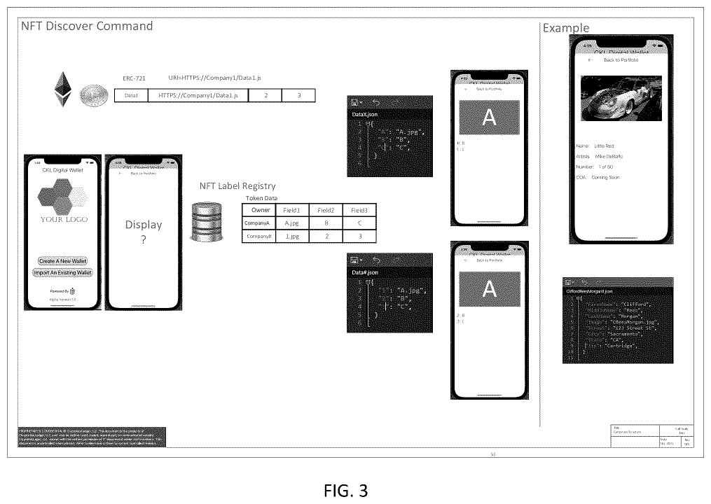

FIG. 3 illustrates a NFT discover command feature, according to some embodiments; and

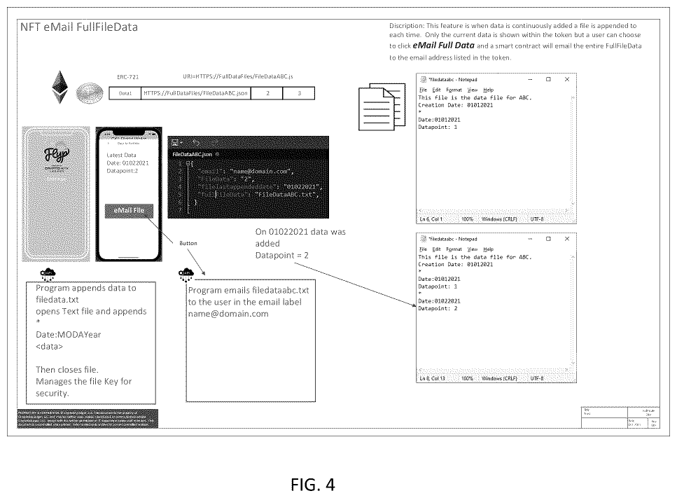

FIG. 4 illustrates a NFT email full file data feature, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to NFT functions. The embodiments provide a means for extending the features of ERC-721 tokens by defining additional JSON file meta data “labels” along with how a digital wallet should display the JSON file meta data labels. The system allows for complete legal documents to be added to a folder to which the JSON file is directed using the IRI contained in the token, thus extending the token's capabilities. The system may also add an email label to a digital wallet to permit the system to transmit data from the IRI storage folder, allowing for the digital wallet to contain the transmitted data.

ERC-721 tokens can be used to send and direct access to data stored in the folder defined by the URI listed in the token. Digital wallets can display more labels in defined ways. Displaying the data in the JSON file requires the digital wallet to know what and how data is stored in the storage folder defined in the JSON file directed to by the URI. By adding complete legal documents and the digital wallet knowing that complete documents of numerous formats (e.g., .DOC, .PDF, .XLS, .TXT) and additional features can be created, thus providing various additional functionalities.

In some embodiments, a registry of token types with defined labels will be stored out on the Internet. In the URI will be a JSON file with “Token Types” that are defined in the Registry that defined all that is needed to properly display that token type.

The embodiments extend the capabilities of digital wallets by enabling the proper display of ERC-721 Tokens. Industry standards have focused on just a few common labels for data stored in the storage folder defined by a tokens URI. The system described herein extends the capabilities of the use of data stored in the storage folder by adding labels, files, and other data. An email label extends the capabilities to send emails to the user which may include data stored in the JSON file. Adding documents allows for various document types to be included, such as legal documents like trust documents that declares the ownership of something to the holder of the token (i.e., the ownership documents of a vehicle).

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102, coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g., a digital camera, scanner, or others) and associated structures and elements operatively coupled to at least one processor and memory of the mobile computing device. Such image capturing component 108 can be operable to capture an image of a label and/or code (e.g. a quick response (QR) code or others) automatically or upon one or more user input commands.

Also shown in FIG. 1 are one or more database(s) These databases can be locally stored in memory or remotely stored in memory that is accessible by computer system 102 via network 130 and may be proprietary, public, or some combination thereof. These databases can also be third-party or system databases in some embodiments and may have one of any manner of structures, privacy measures, and other features and elements. Database(s) can include NFT information and registries that the system 102 sends to user devices via the network 130. All manner of NFT related information may be stored in the one or more databases, according to the embodiments described.

FIG. 2 illustrates a NFT trust to token feature, according to some embodiments. As shown in the example embodiment, a real, physical automobile or other vehicle can be connected to an NFT. This can include information, such as title information in the form of a Trust Document that is a PDF or other file that defines ownership of the vehicle with a particular vehicle identification number (VIN) to the Trust. The addendum can include a beneficiary which is the legal owner of the Token. As such, the NFT Token Owner can be the legal owner of the automobile. Blockchain technology such as Bitcoin, Ethereum or others can be used in some embodiments. Dates can also be included, as well as DMV record(s) or other relevant information in some embodiments.

In some embodiments, the data may be continuously added to a folder within the database. Current data is shown within the token. However, the user may request the full data and a smart contract via email in order to view or otherwise interact with the full file data. The full file data is transmitted to the email address listed in the token.

FIG. 3 illustrates a NFT discover command feature, according to some embodiments. As shown in the example embodiment, labels in a JSON file may not be standard in all cases. As such, a command can be issued to examine a NFT Token JSON file to retrieve labels and look them up in a registry (e.g. a database or other organization scheme stored in non-transitory computer readable memory) in order to determine how a particular wallet or wallets may display them.

FIG. 4 illustrates a NFT email full file data feature, according to some embodiments. As shown in the example embodiment, when data is continuously added to the blockchain, a file is appended to the chain at each stop. However, only current data is shown within a token, but a user can choose to select a NFT email full file data function in some instances. This can be provided in smart contracts in some instances and can cause an email with the full file data to be sent to the email address listed in the token.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A method for providing a non-fungible token NFT program stored in non-transitory computer readable memory that, when executed by a processor causes a computer to perform the steps of:
retrieving an NFT token JSON file and determining at least one label stored in the JSON file;
checking at least one registry for display information associated with the at least one label; and
displaying the NFT in an NFT wallet according to the display information.

2. The method of claim 1, further comprising the step of issuing a command to examine an NFT token JSON file.

3. The method of claim 2, further comprising the step of retrieving the at least one label.

4. The method of claim 3, further comprising the step of searching the at least one label in a registry to determine a means of displaying the information associated with the at least one label.

5. The method of claim 1, wherein an email is associated with the NFT wallet.

6. The method of claim 1, wherein the email is capable of receiving data from the NFT token.

7. The method of claim 1, wherein the email is capable of receiving full file data from the NFT token.

8. The method of claim 7, wherein a database stores full file data capable of being retrieved, via a user request, via email.

9. The method of claim 1, wherein the at least one label relates to a legal document.

10. A system for providing a NFT feature extension, the system comprising:
an NFT token JSON file including at least one label stored in the NFT token JSON file;
at least one registry capable of checking for display information associated with the at least one label; and
an NFT wallet containing the NFT and displaying information contained in the NFT token JSON file.

11. The system of claim 10, further comprising the issuance of a command to examine an NFT token JSON file.

12. The system of claim 11, wherein the at least one label is searched and retrieved from the registry to determine a means of displaying the information associated with the at least one label.

13. The system of claim 12, wherein an email is associated with the NFT wallet.

14. The system of claim 13, wherein the email is capable of receiving data from the NFT token.

15. The system of claim 14, wherein the email is capable of receiving full file data from the NFT token.

16. The system of claim 15, wherein a database stores full file data capable of being retrieved, via a user request, via email.

17. The system of claim 16, wherein the at least one label relates to a legal document.
